(19) United States
(12) Patent Application Publication
(10) Pub. No.: US 2007/0018841 A1
(43) Pub. Date: Jan. 25, 2007

(54) High voltage proximity warning system utilizing wireless sensors and method

(76) Inventor: Irvin Howard Nickerson, Key West, FL (US)

Correspondence Address: IRVIN H. NICKERSON, 2127 KING MESA DR., HENDERSON, NV, 89012, US

(21) Appl. No.: 11/164,039

(22) Filed: Nov. 8, 2005

Related U.S. Application Data
(60) Provisional application No. 60/630,012, filed on Nov. 22, 2004.

(51) Int. Cl. G08B 21/00

(52) U.S. Cl. 340/685; 343/713

(57) ABSTRACT

A high voltage proximity warning system utilizing wireless sensors for preventing heavy equipment from contacting high voltage lines is provided. The warning system is adapted for use with mobile heavy equipment that can be used around overhead power transmission lines. The alarm system consists of a number of wireless radio linked proximity antennas mounted on heavy equipment in locations that could possibly come into contact with high voltage lines. These wireless antennas detect the electric field in the proximity of the high voltage lines and transmits signals to a control panel located in the proximity of the operator of the equipment. The resulting signal level is displayed on the control panel along with an alarm setpoint. If the signal level rises above the alarm setpoint, the control panel provides a visual alarm indication, an audio alarm annunciation, and control signals that can directly inhibit specific functions of the heavy equipment.

### CROSS-REFERENCED TO RELATED APPLICATION

This Application claims the benefit of U.S. Provisional Application Ser. No. 60/630,012, filed Nov. 22, 2004.

### BACKGROUND OF THE INVENTION

This invention relates to warning devices for proximity of vehicles including heavy equipment, television trucks or any other vehicle that may come into contact with a high-voltage power lines avoiding dangerous and damaging contact.

There are known sensors of proximity of vehicles to high-voltage power lines, but none with the high sensitivity, precision of detection, flexibility, and extensive protective coverage to equipment operators of heavy equipment taught by this invention.

Dangerous and damaging contact of high-voltage power lines by vehicles continues to be a problem to equipment operators, to their rescuers, to affected users of electricity, to power companies, to construction companies and to other users of the vehicles.

Examples of most-closely related known but different devices are disclosed in the following patents:

U.S. Patent Documents

| | | |
|---|---|---|
| 2615969 | October, 1952 | Albrecht. |
| 2730245 | January, 1956 | Auld. |
| 2789282 | April, 1957 | Winters |
| 3125751 | March, 1964 | Winters. |
| 3141156 | July, 1964 | Freedman et al. |
| 3168729 | February, 1965 | Volberg |
| 3201775 | August, 1965 | Pedersen. |
| 3733597 | May, 1973 | Healey et al. |
| 3745549 | July, 1973 | Jepperson et al. |
| 3786468 | January, 1974 | Moffitt. |
| 3833898 | September, 1974 | Wilkinson. |
| 4064997 | December, 1977 | Holland et al. |
| 4408195 | October, 1983 | Tullis et al. |
| 4649375 | March, 1987 | Duppong et al. |
| 4675664 | June, 1987 | Cloutier et al. |
| 5001465 | March, 1991 | Siegel. |
| 6600426 | July, 2003 | Sacks et al. |
| 6853307 | February, 2005 | Nickerson. |

Foreign Patent Documents

| | | |
|---|---|---|
| 261364 | October, 1964 | AU. |
| 758721 | May, 1967 | CA. |
| 963553 | February, 1975 | CA. |
| 1363156 | September, 1964 | FR. |
| 1061753 | March, 1967 | GB. |
| 1367641 | September, 1974 | GB. |
| 1367642 | September, 1974 | GB. |

### SUMMARY OF THE INVENTION

Objects of patentable novelty and utility taught by this invention are to provide a high voltage proximity warning system utilizing wireless sensors and method which:

employs a number of radio linked proximity antennas strategically located on the heavy equipment to detect the electric field of high voltage lines;

avoids electric field shadowing by effective positioning of the plurality of the radio linked proximity antennas;

provides sufficiently accurate detection and communication of nearness of high-voltage lines to allow heavy equipment and vehicles to work closer to them than previously without dangerous and damaging contact;

provides a centrally located control panel to communicate with numerous antennas without the use of cable reels or wire antennas;

provides the option of multiple operator panels to communicate with numerous antennas when the heavy equipment is to be operated remotely;

provides effective alarm communication of high voltage nearness to the operators of the heavy equipment, remote operators or monitors of the heavy equipment, and to personnel in the immediate vicinity of the heavy equipment; and

provides heavy equipment control inhibit functions thereby disabling selective functions of the heavy equipment during alarm conditions.

This invention accomplishes these and other objectives with a high-voltage proximity warning system having a control panel for being positioned in or about a cab of heavy equipment or vehicle, and one or more proximity antennas for being positioned selectively on the heavy equipment or vehicle in predetermined radio communication with the control panel.

The operator panel is adapted to be operable conveniently by an operator in a cab position where it is readily visible. The front of the operator panel includes an operator display, and may include one or more warning lights, one or more alarm lights and a plurality of pushbuttons. The operator display provides an indication of a signal level and an alarm setpoint and may also be used during the configuration of the device. The pushbuttons may include a power pushbutton, a raise and lower pushbutton used to raise and lower the alarm setpoint, and a configure/test pushbutton. The configure/test pushbutton may be used in conjunction with the raise and lower pushbuttons to configure the operator panel or test specific functions of the operator panel. The back of the operator panel may include one or more data terminals to provide a connection to a remote panel and may include a plurality of electrical connections to electrical devices that may include a power source, one or more speakers, and one or more warning relays and alarm relays to control remote devices.

In an alternate embodiment, a remote panel may be used in conjunction with the operator panel to provide a convenient connection point for the various panel interfaces. The remote panel may include a data terminal for connection of a data cable connecting the operator panel with the remote panel, electrical power connections, speaker connections, and pluralities of warning and alarm relays to control remote devices.

A plurality of radio linked proximity antennas are mounted on the heavy equipment in locations that may come into contact with the high voltage lines. Each radio linked proximity antenna consists of two capacitive sensors. One of the sensors is closely capacitively coupled to the frame of the heavy equipment, while the other sensor is positioned to sense the electric field of the high voltage lines. The voltage difference between the two sensors represents the approximate proximity of the high voltage lines and is wirelessly transmitted to a transceiver that is electrically connected to the operator panel. In an alternate embodiment, the transceiver may be electrically connected to the remote panel.

In another embodiment, multiple control panels can be used with the radio linked proximity antennas. The is particularly useful for use with insulated boom trucks, manlifts, concrete pump trucks, or any heavy equipment where operation or monitoring can be accomplished from more than one location.

The above and other objects, features, and advantages of the present invention should become even more readily apparent to those skilled in the art upon a reading of the following detailed description in conjunction with the drawings wherein there is shown and described illustrative embodiments of the invention.

### DESCRIPTION OF THE PRIOR ART

There are known sensors of proximity of vehicles to high-voltage power lines, but none have the flexibility of use and the precision of detection of proximity taught by this invention.

In U.S. Pat. No. 6,853,307, Nickerson discusses a proximity warning device that uses a plurality of straight line proximity antennas to sense the proximity of the high voltage lines. This type of device is sufficient for use on heavy equipment such as boom cranes that utilize straight booms, but is clearly unacceptable for a new generation of cranes and equipment that utilize articulated booms. It is also unsuitable for use on insulated boom trucks such as insulated man-lifts and bucket trucks.

Numerous other patents discuss single wire proximity devices. A study conducted by the Bureau of Mines on Feb. 22, 1980 entitled “Evaluation of Proximity Warning Devices” discounts single wire devices as being unreliable due to the characteristic shadowing of the antenna by the crane boom which diminishes, and often disables its ability to detect the high voltage lines. During this specific study, all heavy equipment utilizing single wire antenna proximity warning devices came into direct contact with the high voltage lines during the evaluation.

The 1980 study further concluded “The recommended design would utilize multiple point sensor located on all sides of the boom and along the length of the boom, with each sensor being separately monitored to report an alarm whenever its output exceeds a preset threshold. The electronics would use a microprocessor for self-calibration and more complex alarm/logic analysis”. This invention exceeds the recommendations of the study.

### BRIEF DESCRIPTION OF DRAWINGS

FIG. 100 is a functional block diagram of the invention.

FIG. 101 is a functional block diagram of the radio linked proximity antenna.

FIG. 102 is a functional block diagram of the line contact sensor antenna.

FIG. 103 is a perspective front view of the operator panel.

FIG. 104 is a perspective rear view of the operator panel.

FIG. 105 is a plan view of the remote panel.

FIG. 106 is a side view of the remote panel.

FIG. 107 is a plan view of the remote panel transceiver antenna.

FIG. 108 is a side view of the remote panel transceiver antenna.

FIG. 109 is an exploded view of the radio linked proximity antenna.

FIG. 110 is an exploded view of a line contact sensor and the line contact sensor antenna.

FIG. 111 is a top perspective view of the heavy equipment showing locations of mounted components.

FIG. 112 is a bottom perspective view of the heavy equipment showing locations of mounted components.

### DESCRIPTION OF PREFERRED EMBODIMENT

Listed numerically below with reference to the drawings and terms used to describe features of this invention. These terms and numbers assigned to them designate the same features throughout this description.
1 Alarm light
2 Alarm relay
3 Alarm setpoint
4 Antenna base
5 Antenna battery
6 Antenna circuit board
7 Antenna compression circuit
8 Antenna controller
9 Antenna cover
10 Antenna ground plane
11 Antenna transceiver
12 Antenna transceiver antenna
13 Circuit board screw
14 Cover screw
15 Data and power connector cable
16 External controls
17 Heavy equipment
18 High voltage lines
19 Line contact sensor
20 Line contact sensor antenna
21 Line contact sensor antenna base
22 Line contact sensor antenna circuit board
23 Line contact sensor antenna communications connector
24 Line contact sensor antenna controller
25 Line contact sensor antenna cover
26 Line contact sensor antenna power connector
27 Line contact sensor antenna power supply
28 Line contact sensor antenna transceiver
29 Line contact sensor antenna transceiver antenna
30 Line contact sensor base
31 Line contact sensor circuit board
32 Line contact sensor communications cable
33 Line contact sensor communications connector
34 Line contact sensor compression circuitry
35 Line contact sensor controller
36 Line contact sensor cover
37 Line contact sensor ground plane
38 Lower pushbutton
39 On-off pushbutton
40 Operator display
41 Operator panel
42 Operator panel controller
43 Operator panel data and power connector
44 Operator panel power supply
45 Operator pushbuttons
46 Power input
47 Radio link
48 Radio linked proximity antenna
49 Raise pushbutton
50 Remote panel
51 Remote panel controller
52 Remote panel data and power connector
53 Remote panel power connector
54 Remote panel power supply
55 Remote panel relay connector
56 Remote panel speaker connector
57 Remote panel transceiver
58 Remote panel transceiver antenna
59 Remote panel transceiver antenna cable
60 Remote panel transceiver antenna connector
61 Remote panel transceiver connector
62 Signal level
63 Spacer
64 Spacer screw
65 Speaker
66 Speaker amplifier
67 Warning and alarm lights
68 Warning light
69 Warning relay
70 Warning setpoint

Listed in alphabetical order below are the terms and definitions used in the description and drawings below with reference to other terms and drawings used to describe features of this invention. These terms and definitions designate the same features throughout this description.

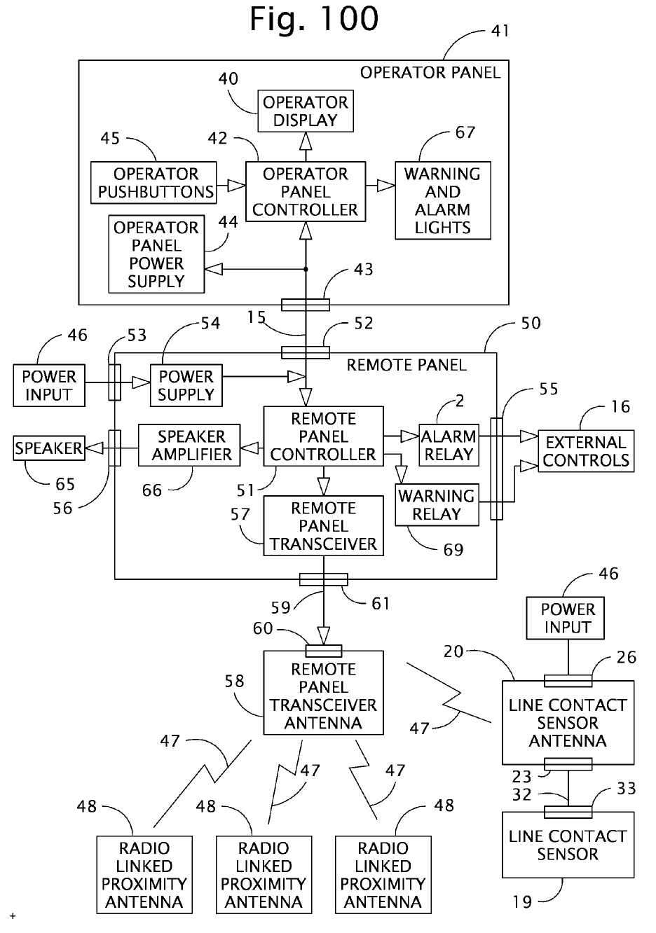

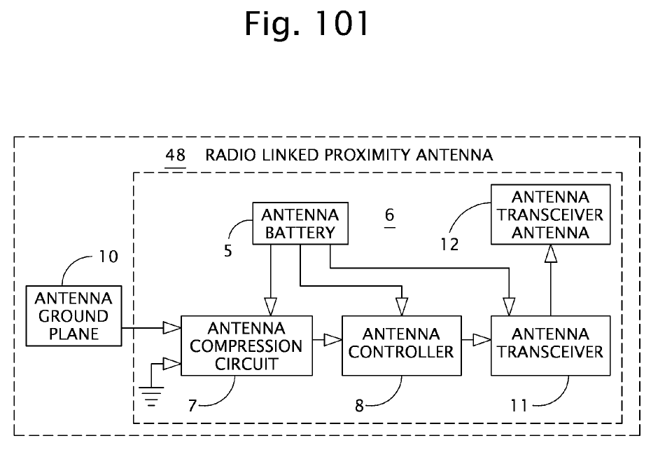

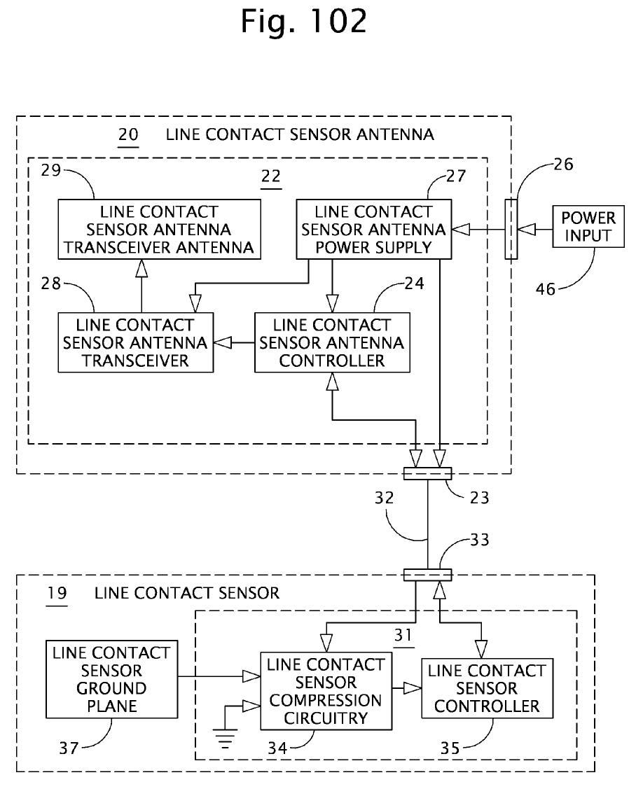

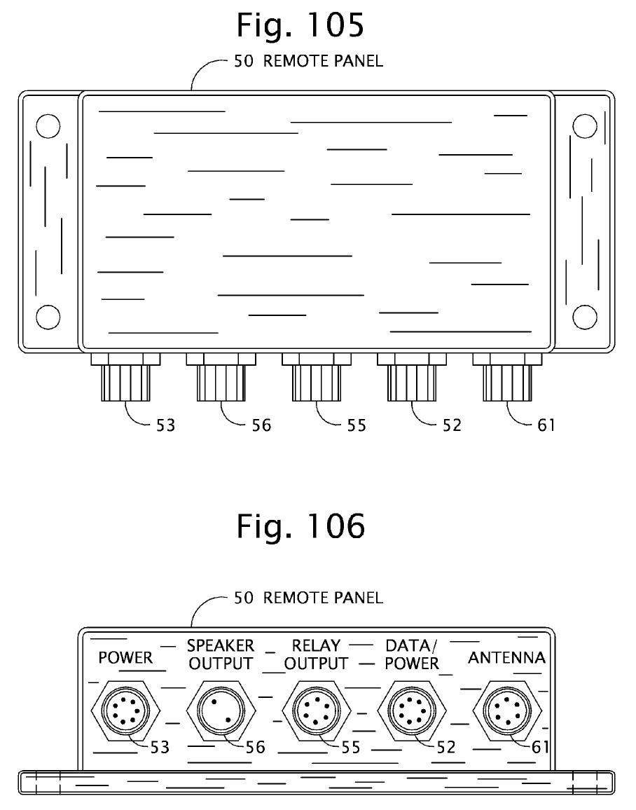

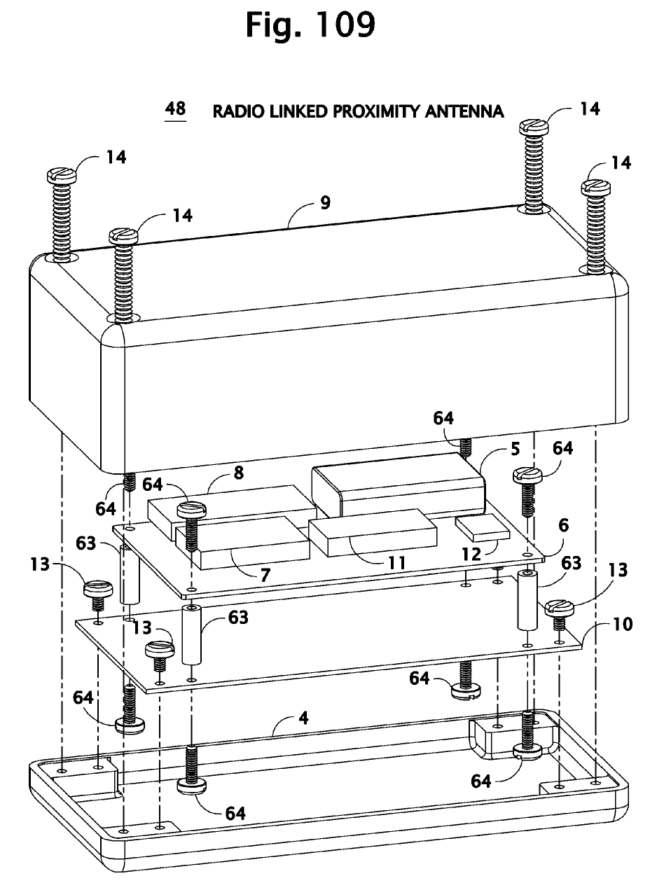

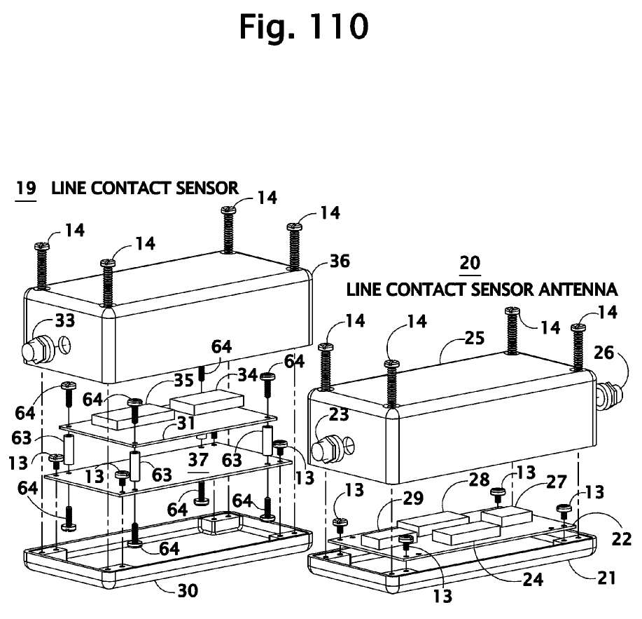

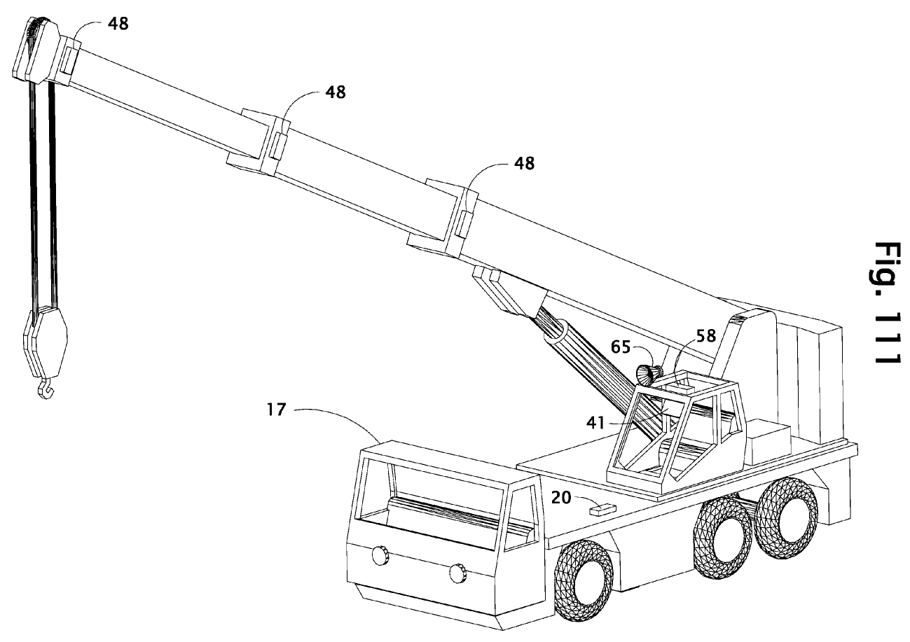

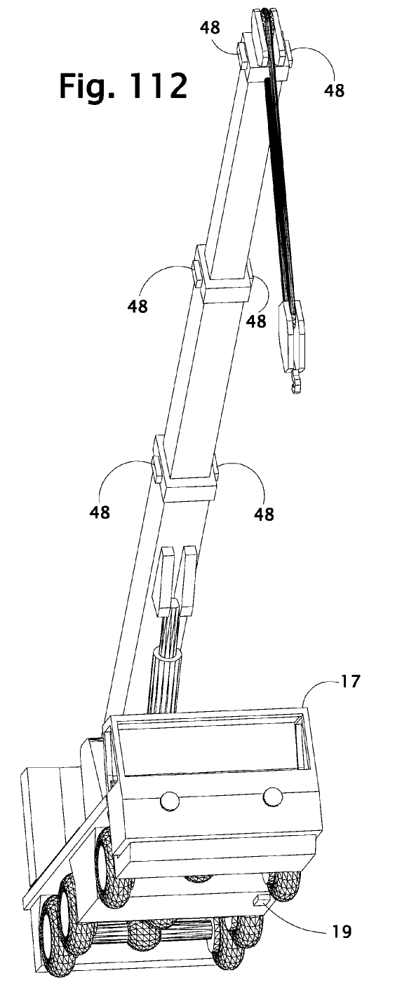

Definition List 1

| Term | Definition |
|---|---|
| Alarm light (1) | An alarm light (1) is lighted whenever the |
| | signal level (62) exceeds the value of the |
| | alarm setpoint (3) as shown on the |
| | operator display (40). (Ref: FIG. 103). |
| Alarm relay (2) | An alarm relay (2) is actuated whenever |
| | the signal level (62) exceeds the value of |
| | the alarm setpoint (3) as shown on the |
| | operator display (40). (Ref: FIGS. 100 |
| | and 103). |
| Alarm setpoint (3) | An alarm setpoint (3) is the value of the |
| | signal level (62) displayed on the |
| | operator display (40) that will result in |
| | an alarm condition which includes an |
| | alarm annunciation by means of the |
| | speaker (65), the lighting of the alarm |
| | light (1), and the actuation of the |
| | external controls (16) by means of the |
| | alarm relay (2). (Ref: FIG. 103). |
| Antenna base (4) | An antenna base (4) is that portion of the |
| | radio linked proximity antenna (48) that |
| | is securely attached to the heavy |
| | equipment (17) upon which the |
| | remainder of the components the radio |
| | linked proximity antenna (48) is |
| | mounted. (Ref: FIG. 109). |
| Antenna battery (5) | An antenna battery (5) provides power to |
| | the electrical circuitry of the radio linked |
| | proximity antenna (48). (Ref: FIG. 109). |
| Antenna circuit board | An antenna circuit board (6) contains the |
| (6) | electrical components of the radio linked |
| | proximity antenna (48) including the |
| | antenna controller (8), the antenna |
| | battery (5), the antenna compression |
| | circuit (7), the antenna transceiver (11), |
| | and the antenna transceiver antenna |
| | (12). (Ref: FIG. 109). |
| Antenna compression | An antenna compression circuit (7) |
| circuit (7) | dynamically compresses the received |
| | electric field strength signal from |
| | approximately 16 decades of electric |
| | field strength signal into approximately |
| | 2 decades of displayed signal level (62). |
| | (Ref: FIGS. 101, and 109). |
| Antenna controller (8) | An antenna controller (8) controls the |
| | functions of the radio linked proximity |
| | antenna (48) including measuring the |
| | compressed output of the antenna |
| | compression circuit (7) and directing the |
| | output to the antenna transceiver (11). |
| | (Ref: FIGS. 101, and 109). |
| Antenna cover (9) | An antenna cover (9) shrouds the |
| | components of the radio linked |
| | proximity antenna (48) and attaches to |
| | the antenna base (4) thereby protecting |
| | the components of the radio linked |
| | proximity antenna (48) from the |
| | elements. (Ref: FIG. 109). |
| Antenna ground plane | An antenna ground plane (10) is |
| (10) | contained in the radio linked proximity |
| | antenna (48) and is closely capacitively |
| | coupled to the frame of the heavy |
| | equipment (17). The voltage difference |
| | between the antenna ground plane (10) |
| | and the antenna circuit board (6) |
| | provides the electric field strength signal |
| | to the antenna compression circuit (7). |
| | (Ref: FIGS. 101, and 109). |
| Antenna transceiver | An antenna transceiver (11) is contained |
| (11) | in the radio linked proximity antenna |
| | (48) and provides the means to transmit |
| | and receive information by means of |
| | radio frequency transmissions between |
| | the radio linked proximity antenna (48) |
| | and the remote panel (50). (Ref: FIGS. |
| | 101, and 109). |
| Antenna transceiver | An antenna transceiver antenna (12) is |
| antenna (12) | contained in the radio linked proximity |
| | antenna (48) and provides the antenna |
| | function for the antenna transceiver (11). |
| | (Ref: FIGS. 101, and 109). |
| Circuit board screw | A circuit board screw (13) secures the |
| (13) | antenna ground plane (10) to the |
| | antenna base (4), the line contact sensor |
| | ground plane (37) to the line contact |
| | sensor base (30), and the line contact |
| | sensor antenna circuit board (22) to the |
| | line contact sensor antenna base (21). |
| | (Ref: FIGS. 109, and 110). |
| Control Panel | A control panel is a device that combines |
| | the functions of the operator panel (41), |
| | the remote panel (50), and the remote |
| | panel transceiver antenna (58). (Ref: FIG. |
| | 100) |
| Cover screw (14) | A cover screw (14) is used to secure the |
| | antenna cover (9) to the antenna base |
| | (4), the line contact sensor cover (36) to |
| | the line contact sensor base (30), and |
| | the line contact sensor antenna cover |
| | (25) to the line contact sensor antenna |
| | base (21). (Ref: FIGS. 109, and 110). |
| Data and power | A data and power connector cable (15) |
| connector cable (15) | provides the means to transfer data |
| | between the operator panel (41) and the |
| | remote panel (50). (Ref: FIG. 100). |
| External controls (16) | External controls (16) include any |
| | electrical control functions of the heavy |
| | equipment (17) that could be actuated to |
| | provide a protective action initiated by |
| | the remote panel (50) by means of the |
| | alarm relay (2) or the warning relay (69). |
| | (Ref: FIG. 100). |
| Heavy equipment (17) | Heavy equipment (17) includes cranes |
| | and any other motorized equipment or |
| | vehicle that could possibly come into |
| | contact with the high voltage lines (18) |
| | during the course of operation. (Ref: |
| | FIGS. 111 and 112). |
| High voltage lines (18) | High voltage lines (18) consist of high |
| | voltage wires mounted upon poles that |
| | the heavy equipment (17) could contact |
| | during the course of operation. |
| Line contact sensor | A line contact sensor antenna (20) is |
| antenna (20) | mounted on the heavy equipment (17) in |
| | a position where it can communicate |
| | with the remote panel transceiver (57). |
| | The line contact sensor antenna (20) |
| | serves as the transceiver for the line |
| | contact sensor (19). (Ref: FIGS. 100, |
| | 102, 110, and 111). |
| Line contact sensor | A line contact sensor antenna base (21) |
| antenna base (21) | is the bottom portion of the enclosure |
| | for the line contact sensor antenna (20). |
| | (Ref: FIG. 110). |
| Line contact sensor | A line contact sensor antenna |
| antenna | communications connector (23) is |
| communications | attached to the line contact sensor |
| connector (23) | antenna (20) and provides a means for |
| | the line contact sensor communications |
| | cable (32) to pass electrical information |
| | from the line contact sensor (19) to the |
| | line contact sensor antenna (20). (Ref: |
| | FIG. 100, 102, and 110). |
| Line contact sensor | A line contact sensor antenna controller |
| antenna controller | (24) is contained in the line contact |
| (24) | sensor antenna (20) and provides a |
| | means to communicate electrical |
| | information from the line contact sensor |
| | (19) to the line contact sensor antenna |
| | (20) and present the information to the |
| | line contact sensor antenna transceiver |
| | (28) to transmit the information by radio |
| | link (47) to the remote panel transceiver |
| | antenna (58). (Ref: FIGS. 102, and 110). |
| Line contact sensor | A line contact sensor antenna cover (25) |
| antenna cover (25) | is provided to cover the electrical |
| | components of the line contact sensor |
| | antenna (20) and protect the |
| | components from the weather. (Ref: FIG. |
| | 110). |
| Line contact sensor | A line contact sensor antenna power |
| antenna power | connector (26) is provided to allow a |
| connector (26) | power input (46) to be connected to the |
| | line contact sensor antenna (20) and |
| | subsequently supply power to the line |
| | contact sensor (19). (Ref: FIGS. 100, |
| | 102, and 110). |
| Line contact sensor | A line contact sensor antenna power |
| antenna power supply | supply (27) is contained in the line |
| (27) | contact sensor (19) and provides |
| | regulated voltages for the operation of |
| | the line contact sensor antenna (20) and |
| | the line contact sensor (19). (Ref: FIGS. |
| | 102, and 110). |
| Line contact sensor | A line contact sensor antenna transceiver |
| antenna transceiver | (28) contained in the line contact sensor |
| (28) | antenna (20) and provides a means for |
| | the line contact sensor signals to be |
| | communicated by means of the radio |
| | link (47) to the remote panel (50). (Ref: |
| | FIGS. 102, and 110). |
| Line contact sensor | A line contact sensor antenna transceiver |
| antenna transceiver | antenna (29) is contained in the line |
| antenna (29) | contact sensor antenna (20) and |
| | provides a means for the line contact |
| | sensor antenna transceiver (28) to |
| | communicate by means of the radio link |
| | (47) from the line contact sensor |
| | antenna transceiver (28) to the remote |
| | panel (50). (Ref: FIGS. 102, and 110). |
| Line contact sensor | A line contact sensor base (30) is the |
| base (30) | bottom portion of the enclosure for the |
| | line contact sensor (19). (Ref: FIG. 110). |
| Line contact sensor | A line contact sensor circuit board (31) |
| circuit board (31) | contains the electrical components of the |
| | line contact sensor (19) including the |
| | line contact sensor compression circuitry |
| | (34) and the line contact sensor |
| | controller (35). (Ref: FIGS. 102 and 110). |
| Line contact sensor | A line contact sensor communications |
| communications cable | cable (32) is provided to communicate |
| (32) | electrical signals between the line |
| | contact sensor (19) and the line contact |
| | sensor antenna (20). (Ref: FIGS. 100, |
| | and 102). |
| Line contact sensor | A line contact sensor communications |
| communications | connector (33) is attached to the line |
| connector (33) | contact sensor cover (36) and provides a |
| | means for the line contact sensor |
| | communications cable (32) to connect to |
| | the line contact sensor (19) and allow |
| | electrical communications between the |
| | line contact sensor (19) and the line |
| | contact sensor antenna (20). (Ref: FIGS. |
| | 100, 102, and 110). |
| Line contact sensor | Line contact sensor compression |
| compression circuitry | circuitry (34) is located on the line |
| (34) | contact sensor circuit board (31) which is |
| | located in the line contact sensor (19). |
| | The line contact sensor compression |
| | circuitry (34) provides signal |
| | compression of the signal from the |
| | electric field of the high voltage lines |
| | (18). (Ref: FIGS. 102, and 110). |
| Line contact sensor | A line contact sensor cover (36) is |
| cover (36) | provided to cover the line contact sensor |
| | (19) components to protect the |
| | components from the weather. (Ref: FIG. |
| | 110). |
| Line contact sensor | A line contact sensor ground plane (37) |
| ground plane (37) | is contained in the line contact sensor |
| | (19) and is capacitively coupled to the |
| | frame of the heavy equipment (17). The |
| | voltage difference between the line |
| | contact sensor ground plane (37) and |
| | the line contact sensor circuit board (31) |
| | provides the line contact signal to the |
| | line contact sensor compression circuit |
| | (34). (Ref: FIGS. 102, and 110). |
| Lower pushbutton (38) | A lower pushbutton (38) is mounted on |
| | the front of the operator panel (41) and |
| | provides a means for the operator to |
| | lower the alarm setpoint (3) setting on |
| | the operator display (40). The lower |
| | pushbutton (38) also provides a means |
| | to change the value of the warning |
| | setpoint (70). (Ref: FIG. 103). |
| On-off pushbutton | An on-off pushbutton (39) is mounted |
| (39) | on the front of the operator panel (41) |
| | and provides a means for the operator to |
| | energize and de-energize the operator |
| | panel (41). (Ref: FIG. 103). |
| Operator display (40) | An operator display (40) is located on |
| | the front of the operator panel (41) and |
| | displays the highest indication of the |
| | electric field strength as the signal level |
| | (62) and the value of the alarm setpoint |
| | (3). (Ref: FIGS. 100, and 103). |
| Operator panel (41) | The operator panel (41) is mounted in |
| | the immediate vicinity of the operator of |
| | the heavy equipment (17) and allows the |
| | operator to observe the signal level (62), |
| | the alarm setpoint (3), the warning light |
| | (68), and the alarm light (1). The |
| | operator is also able to operate the on- |
| | off pushbutton (39), the lower |
| | pushbutton (38) and the raise |
| | pushbutton (49). (Ref: FIGS. 100, 103, |
| | 104, and 111). |
| Operator panel | An operator panel controller (42) is |
| controller (42) | contained in the operator panel (41) and |
| | provides control of the functions of the |
| | operator panel (41) and controls the |
| | communications to the remote panel |
| | (50). (Ref: FIG. 100). |
| Operator panel power | An operator panel power supply (44) is |
| supply (44) | contained in the operator panel (41) and |
| | provides regulated voltages for the |
| | operation of the operator panel (41). |
| | (Ref: FIG. 100). |
| Operator pushbuttons | Operator pushbuttons (45) are mounted |
| (45) | on the front of the operator panel (41) |
| | and consist of an on-off pushbutton |
| | (39), a lower pushbutton (38), and a |
| | raise pushbutton (49). (Ref: FIG. 100, |
| | and 103). |
| Power input (46) | Power input (46) is provided by the |
| | heavy equipment (17) and is converted |
| | by the remote panel power supply (54) to |
| | accurate power supply values to be used |
| | by the electrical components of the |
| | remote panel (50) and the operator panel |
| | (41). The power input (46) is also |
| | supplied to the line contact sensor |
| | antenna (20) which subsequently |
| | provides power to the line contact |
| | sensor (19). (Ref: FIGS. 100, and 102). |
| Radio link (47) | A radio link (47) is provided to |
| | communicate by means of radio |
| | frequency transmissions between the |
| | remote panel transceiver antenna (58), |
| | the radio linked proximity antennas (48), |
| | and the line contact sensor antenna (20). |
| | (Ref: FIG. 100). |
| Radio linked proximity | A series of radio linked proximity |
| antenna (48) | antennas (48) are mounted in strategic |
| | locations on the heavy equipment (17) to |
| | sense the electric field from the high |
| | voltage lines (18) and communicate the |
| | corresponding values of electric field |
| | strength to the remote panel transceiver |
| | antenna (58). (Ref: FIGS. 100, 101, 109, |
| | 111, and 112). |
| Raise pushbutton (49) | A raise pushbutton (49) is mounted on |
| | the front of the operator panel (41) and |
| | provides a means for the operator to |
| | raise the alarm setpoint (3) setting on |
| | the operator display (40). The raise |
| | pushbutton (49) also provides a means |
| | to change the value of the warning |
| | setpoint (70). (Ref: FIG. 103). |
| Remote panel (50) | A remote panel (50) is mounted in a |
| | location remote to the operator panel |
| | (41) and provides data and power |
| | functions to the operator panel (41), and |
| | power and control functions to the |
| | remote panel transceiver antenna (58). |
| | The remote panel (50) also provides an |
| | output to a speaker (65) and connections |
| | to the external controls (16). (Ref: FIGS. |
| | 100, 105, and 106). |
| Remote panel | A remote panel controller (51) provides a |
| controller (51) | means to control the electrical functions |
| | of the remote panel (50) including the |
| | speaker amplifier (66), the alarm relay |
| | (2), the warning relay (69), and the |
| | remote panel transceiver (57). The |
| | remote panel controller (51) also |
| | provides control of the communication |
| | between the remote panel (50) and the |
| | operator panel (41). (Ref: FIG. 100). |
| Remote panel data | A remote panel data and power |
| and power connector | connector (52) is provided to allow |
| (52) | electrical connection between the data |
| | and power connector cable (15) and the |
| | remote panel (50). (Ref: FIGS. 100, 105, |
| | and 106). |
| Remote panel power | A remote panel power connector (53) is |
| connector (53) | provided to allow the power input (46) to |
| | be applied to the remote panel power |
| | supply (54). (Ref: FIGS. 100, 105, and |
| | 106). |
| Remote panel power | A remote panel power supply (54) |
| supply (54) | provides power to the electrical |
| | functions of the remote panel (50) |
| | including the speaker amplifier (66), the |
| | remote panel controller (51), the alarm |
| | relay (2), the warning relay (69), the |
| | remote panel transceiver (57), and the |
| | operator panel power supply (44). (Ref: |
| | FIG. 100). |
| Remote panel relay | A remote panel relay connector (55) is |
| connector (55) | mounted on the remote panel (50) and is |
| | provided to allow the alarm relay (2) and |
| | the warning relay (69) to be connected to |
| | the external controls (16). (Ref: FIGS. |
| | 100, 105, and 106). |
| Remote panel speaker | A remote panel speaker connector (56) is |
| connector (56) | mounted on the remote panel (50) and is |
| | provided to allow the speaker amplifier |
| | (66) located in the remote panel (50) to |
| | drive the speaker (65). (Ref: FIGS. 100, |
| | 105, and 106). |
| Remote panel | A remote panel transceiver (57) provides |
| transceiver (57) | the power, electrical intelligence, and |
| | radio frequency signals to the remote |
| | panel transceiver antenna (58) by means |
| | of the remote panel transceiver |
| | connector (61), the remote panel |
| | transceiver antenna cable (59), and the |
| | remote panel transceiver antenna |
| | connector (60). (Ref: FIG. 100). |
| Remote panel | A remote panel transceiver antenna (58) |
| transceiver antenna | provides the means for the remote panel |
| (58) | transceiver (57) to communicate with the |
| | radio linked proximity antenna (48) and |
| | the line contact sensor antenna (20) by |
| | means of a radio link (47). (Ref: FIGS. |
| | 100, 107, 108, and 111). |
| Remote panel | A remote panel transceiver antenna |
| transceiver antenna | cable (59) is used to convey the power, |
| cable (59) | intelligence, and radio frequency signals |
| | to the remote panel transceiver antenna |
| | (58) by means of the remote panel |
| | transceiver connector (61) and the |
| | remote panel transceiver antenna |
| | connector (60). (Ref: FIG. 100). |
| Remote panel | A remote panel transceiver antenna |
| transceiver antenna | connector (60) is located on the remote |
| connector (60) | panel transceiver antenna (58) and |
| | provides the electrical connection from |
| | the remote panel transceiver (57), |
| | through the remote panel transceiver |
| | antenna cable (59) to the remote panel |
| | transceiver antenna (58). (Ref: FIGS. |
| | 100, 107, and 108). |
| Remote panel | A remote panel transceiver connector |
| transceiver connector | (61) is located on the remote panel (50) |
| (61) | and conveys electrical signals from the |
| | remote panel transceiver (57) through |
| | the remote panel transceiver connector |
| | (61), through the remote panel |
| | transceiver antenna cable (59), through |
| | the remote panel transceiver antenna |
| | connector (60) and subsequently to the |
| | remote panel transceiver antenna (58). |
| | (Ref: FIGS. 100, 105, and 106). |
| Signal level (62) | A signal level (62) is provided on the |
| | operator display (40) of the operator |
| | panel (41) and consists of a numerical |
| | indication of the highest value of the |
| | compressed electric field strength |
| | sensed by the array of radio linked |
| | proximity antennas (48). (Ref: FIG. 103). |
| Spacer (63) | A spacer (63) is used in the radio linked |
| | proximity antenna (48) to provide a fixed |
| | spacing between the antenna circuit |
| | board (6) and the antenna ground plane |
| | (10) and in the line contact sensor (19) |
| | to provide a fixed spacing between the |
| | line contact sensor circuit board (31) and |
| | the line contact sensor ground plane |
| | (37). (Ref: FIG. 109 and 110). |
| Spacer screw (64) | A spacer screw (64) is used in the radio |
| | linked proximity antenna (48) to connect |
| | the spacer (63) to the antenna ground |
| | plane (10) and the antenna circuit board |
| | (6). The spacer screw (64) is also used in |
| | the line contact sensor (19) to connect |
| | the spacer (63) to the line contact sensor |
| | circuit board (31) and the line contact |
| | sensor ground plane (37). (Ref: FIG. 109 |
| | and 110). |
| Speaker (65) | A speaker (65) is mounted on the heavy |
| | equipment (17) and is used to |
| | annunciate a warning when the warning |
| | light (68) is lighted and is also used to |
| | annunciate an alarm when the alarm |
| | light (1) is lighted. (Ref: FIGS. 100 and |
| | 111). |
| Speaker amplifier (66) | A speaker amplifier (66) is located in the |
| | remote panel (50) and receives audio |
| | annunciations from the remote panel |
| | controller (51), amplifies the |
| | annunciations, and applies the amplified |
| | signal through the remote panel speaker |
| | connector (56) to the speaker (65). (Ref: |
| | FIG. 100). |
| Warning and alarm | Warning and alarm lights (67) are located |
| lights (67) | on the front of the operators panel and |
| | consist of one or more warning lights |
| | (68) and one or more alarm lights (1). |
| | (Ref: FIGS. 100 and 103). |
| Warning light (68) | A warning light (68) is located on the |
| | front of the operator panel (41) and is |
| | lighted whenever the value of the |
| | warning setpoint (70) has been |
| | exceeded. (Ref: FIG. 103). |
| Warning relay (69) | A warning relay (69) is located in the |
| | remote panel (50) and is actuated |
| | whenever the value of the warning |
| | setpoint (70) has been exceeded. (Ref: |
| | FIG. 100). |
| Warning setpoint (70) | A warning setpoint (70) is provided to |
| | allow warning functions such as a |
| | speaker annunciation, warning light (68), |
| | and the actuation of the warning relay |
| | (69) to warn the operator of the heavy |
| | equipment (17) prior to receiving an |
| | alarm condition. The warning setpoint |
| | (70) is set at a predetermined number of |
| | signal units below the alarm setpoint (3). |

Referring to FIGS. 103, 104, and 111, a high voltage proximity warning system utilizing wireless sensors has an operator panel (41), adapted for being positioned in predeterminedly operational, audio and visual nearness to the heavy equipment (17) or vehicle operator in or about the heavy equipment (17), as shown in FIG. 111.

The remote panel (50) is adapted for being positioned in predeterminedly operational, audio and visual remoteness from the operator panel (41). As shown in FIGS. 100, 105, and 106, the remote panel (50) is in predetermined electrical communication with the operator panel (41).

As shown in FIGS. 100 and 111, the remote panel transceiver antenna (58) is adapted for being positioned on the heavy equipment (17) and is in predetermined electrical communication with the remote panel (50).

As shown in FIGS. 111 and 112, the plurality of radio linked proximity antennas (48) are adapted for being positioned selectively on the heavy equipment (17). The radio linked proximity antennas (48) are in predetermined radio communications with the remote panel transceiver antenna (58).

As shown in FIG. 112, the line contact sensor (19) is adapted for being positioned on the underside of the heavy equipment (17).

As shown in FIGS. 100 and 111, the line contact sensor antenna (20) is adapted for being positioned selectively on the upper portion of the heavy equipment (17).

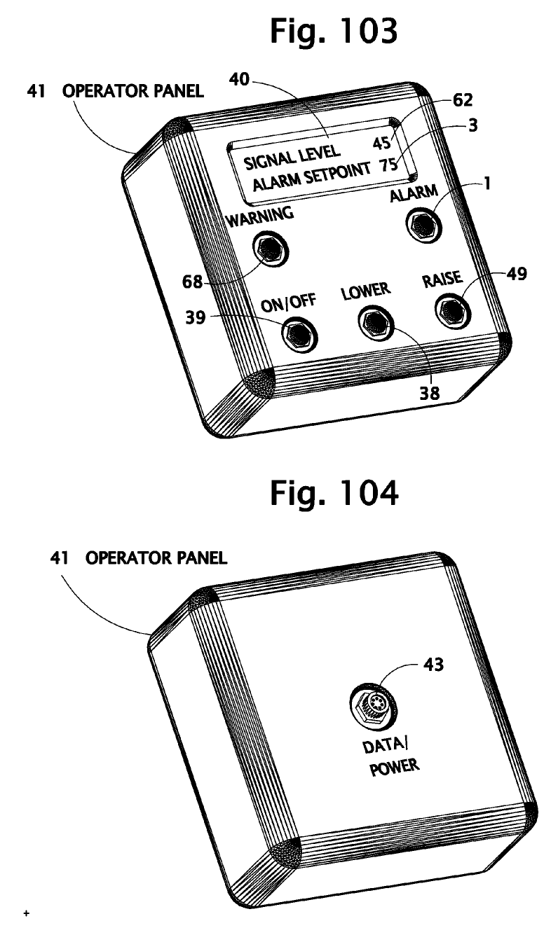

As shown in FIG. 103, the operator panel (41) has a plurality of local data transmitters which include the operator display (40), the warning light (68), the alarm light (1), the on-off pushbutton (39), the lower pushbutton (38), and the raise pushbutton (49). As shown in FIG. 104, the rear view of the operator panel (41) includes the operator panel data and power connector (43).

As shown in FIGS. 105 and 106, the remote panel (50) has a plurality of data terminals which include the remote panel power connector (53), the remote panel speaker connector (56), the remote panel relay connector (55), the remote panel data and power connector (52), and the remote panel transceiver connector (61). The power input (46) to the remote panel (50) is applied through the remote panel power connector (53).

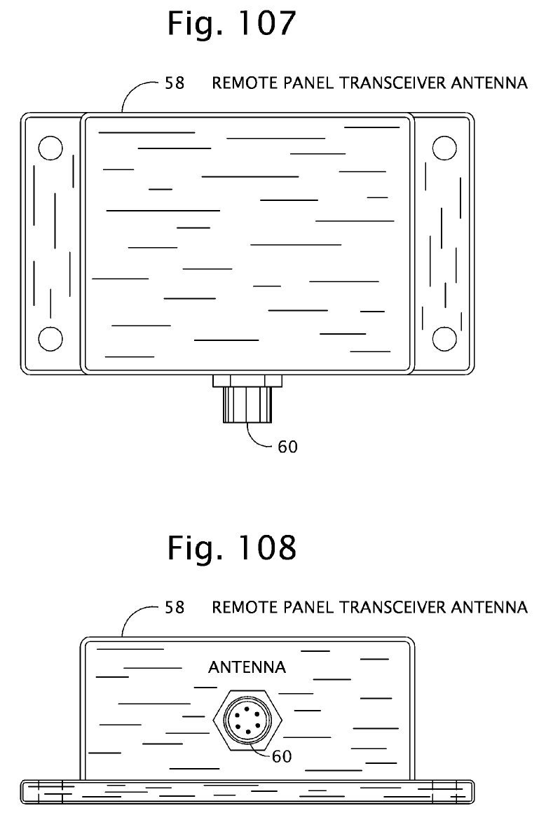

As shown in FIGS. 100, 107 and 108, the remote panel transceiver antenna (58) includes a remote panel transceiver antenna connector (60). The remote panel transceiver antenna cable (59) provides power and predetermined electrical information transfer between the remote panel (50) and the remote panel transceiver antenna (58). The remote panel transceiver connector (61) provides the connection to the remote panel (50) and the remote panel transceiver antenna connector (60) provides the electrical connection to the remote panel transceiver antenna (58).

As shown in FIGS. 100, 104, 105 and 106, the data and power connector cable (15) provides power and predetermined electrical information transfer between the remote panel (50) and the operator panel (41). The remote panel data and power connector (52) provides the connection to the remote panel (50) and the operator panel data and power connector (43) provides the connection to the operator panel (41).

As shown in FIGS. 100 and 102, the power input (46) provides power to the line contact sensor antenna (20) through the line contact sensor antenna power connector (26).

As shown in FIG. 100, the line contact sensor communications cable (32) provides power and predetermined electrical information between the line contact sensor antenna (20) and the line contact sensor (19). The line contact sensor antenna communications connector (23) provides the electrical connection to the line contact sensor antenna (20) and the line contact sensor communications connector (33) provides the electrical connection to the line contact sensor (19).

As shown in FIG. 100, the remote panel transceiver antenna (58) is in predetermined radio communication with the radio linked proximity antenna (48) and the line contact sensor antenna (20) and conveys the radio communications with the radio link (47).

As shown in FIGS. 101, 109, and 111, the antenna cover (9) and the antenna base (4) provide the enclosure for the radio linked proximity antenna (48). The antenna circuit board (6) and the antenna ground plane (10) provide the two capacitive antenna elements to sense the electric field in the vicinity of the radio linked proximity antenna (48). The spacers (63) and the spacer screws (64) connect the antenna circuit board (6) to the antenna ground plane (10) and maintain a fixed distance between the two antenna elements. The circuit board screws (13) fasten the assembly to the antenna base (4). The cover screws (14) fasten the antenna cover (9) to the antenna base (4). The radio linked proximity antenna (48) is attached to the heavy equipment (17) with a suitable adhesive to avoid damaging the critical mechanical components of the heavy equipment (17).

As shown in FIGS. 101 and 109, the antenna battery (5) provides power to the components on the antenna circuit board (6). The antenna compression circuit (7) measures the electrical voltage difference between the antenna ground plane (10) and the ground circuit on the antenna circuit board (6) and amplifies and predeterminedly compresses the resultant signal voltage to a value that can be used by the remainder of the circuitry on the antenna circuit board (6). The antenna controller (8) provides an interface between the antenna compression circuit (7) and the antenna transceiver (11). The antenna transceiver (11) receives the interface signal from the antenna controller (8) and provides the intelligence and radio frequency power to transmit the resulting signal to the antenna transceiver antenna (12). The antenna transceiver antenna (12) provides the physical antenna to transmit and receive the radio link (47) between the radio linked proximity antenna (48) and the remote panel transceiver antenna (58).

FIG. 109 shows the approximate placements of the components of the antenna circuit board (6). Included on the antenna circuit board (6) is the antenna battery (5), the antenna controller (8), the antenna compression circuit (7), the antenna transceiver (111) and the antenna transceiver antenna (12).

As shown in FIG. 100, the remote panel power supply (54) provides power to the electrical components of the remote panel (50). The remote panel transceiver antenna (58) receives information from the radio linked proximity antennas (48) using the radio link (47). The remote panel transceiver (57) receives the electrical information from the remote panel transceiver antenna (58). The remote panel controller (51) receives the electrical information from the remote panel transceiver (57) and calculates a signal level (62) to be predeterminedly electrically communicated to the operator panel (41).

The remote panel controller (51) also determines if the signal level (62) exceeds the warning setpoint (70), in which case, the warning relay (69) would be actuated. The remote panel controller (51) also provides the warning annunciation signal to the speaker amplifier (66) and subsequently to the remote panel speaker connector (56). As shown in FIG. 111, the speaker (65) is mounted in close proximity to the operator of the heavy equipment (17). The speaker (65) is connected to the remote panel speaker connector (56) to provide the warning annunciation.

The remote panel controller (51) also determines if the signal level (62) exceeds the alarm setpoint (3), in which case, the warning annunciation is terminated and the warning relay (69) is unactuated. The alarm relay (2) is actuated and the remote panel controller (51) provides the alarm annunciation signal to the speaker amplifier (66) and subsequently to the remote panel speaker connector (56) and to the speaker (65).

As shown in FIG. 100, the external controls (16) consists of specific control functions of the heavy equipment (17) that can be controlled by the actions of the alarm relay (2) and the warning relay (69) through the remote panel relay connector (55).

As shown in FIGS. 100 and 103, the operator panel power supply (44) obtains power from the remote panel (50) through the operator panel data and power connector (43) and provides regulated power supply voltages to the electrical components contained in the operator panel (41). The operator panel controller (42) obtains predetermined electrical information from the operator pushbuttons (45) and predetermined electrical information from the remote panel (50). The operator panel controller (42) provides predetermined electrical information to the warning and alarm lights 67), the operator display (40) and the remote panel (50) through the operator panel data and power connector (43).

As shown in FIGS. 102, 110, 111, and 112, the line contact function consists of two components, the line contact sensor (19) and the line contact sensor antenna (20). The purpose of the line contact sensor (19) is to detect a voltage potential between the heavy equipment (17) and the ground immediately below the heavy equipment (17). The line contact sensor communications cable (32) communicates the electrical potential difference from the line contact sensor (19) to the line contact sensor antenna (20). The line contact sensor communications connector (33) provides an electrical connection to the line contact sensor (19), while the line contact sensor antenna communications connector (23) provides an electrical connection to the line contact sensor antenna (20).

As shown in FIGS. 102, 110, 111, and 112, the power input (46) provides power to the line contact sensor antenna (20). The line contact sensor antenna power connector (26) provides the physical electrical power connection to the line contact sensor antenna (20). The line contact sensor antenna power supply (27) converts the power from the power input (46) into regulated voltages to supply the electrical power requirements of the line contact sensor antenna (20) and the line contact sensor (19). Electrical power is transmitted through the line contact sensor antenna communications connector (23), through the line contact sensor communications cable (32), and through the line contact sensor communications connector (33) to the line contact sensor (19).

As shown in FIG. 102, the line contact sensor ground plane (37) and the line contact sensor circuit board (31) provides an electrical voltage signal that represents the voltage difference between the heavy equipment (17) and the ground below the heavy equipment (17). The line contact sensor compression circuitry (34) measures and compresses the resultant electrical voltage signal. The line contact sensor controller (35) accepts the compressed voltage signal from the line contact sensor compression circuitry (34) and converts the signal into an electrical signal format that can be accommodated by the line contact sensor antenna (20). The electrical components of the line contact sensor (19) such as the line contact sensor compression circuitry (34) and the line contact sensor controller (35) are mounted on the line contact sensor circuit board (31).

As shown in FIGS. 100 and 102, the line contact sensor antenna controller (24) receives the electrical signal format from the line contact sensor controller (35) by means of the line contact sensor communications connector (33), the line contact sensor communications cable (32), and the line contact sensor antenna communications connector (23). The line contact sensor antenna controller (24) reformats the electrical information received from the line contact sensor controller (35). The line contact sensor antenna transceiver (28) receives the information from the line contact sensor antenna controller (24) and provides a radio frequency signal that contains the electrical intelligence received from the line contact sensor antenna controller (24). The line contact sensor antenna transceiver antenna (29) receives the radio frequency signal from the line contact sensor antenna transceiver (28) and transmits the signal by radio link (47) to be received by the remote panel transceiver antenna (58). The electrical components of the line contact sensor antenna (20) including the line contact sensor antenna power supply (27), the line contact sensor antenna controller (24), the line contact sensor antenna transceiver (28), and the line contact sensor antenna transceiver antenna (29) are mounted on the line contact sensor antenna circuit board (22).

As shown in FIGS. 102 and 110, the line contact sensor cover (36) and the line contact sensor base (30) provide the enclosure for the line contact sensor (19). The line contact sensor circuit board (31) and the line contact sensor ground plane (37) provide the two capacitive antenna elements to sense the electric field created by a voltage potential between the heavy equipment (17) and the ground beneath the heavy equipment (17). The spacers (63) and the spacer screws (64) connect the line contact sensor circuit board (31) to the line contact sensor ground plane (37) and maintain a fixed distance between the two capacitive antenna elements. The circuit board screws (13) fasten the assembly to the line contact sensor base (30). The cover screws (14) fasten the line contact sensor cover (36) to the line contact sensor base (30).

As shown in FIGS. 102 and 110, the line contact sensor antenna cover (25) and the line contact sensor antenna base (21) provide the enclosure for the line contact sensor antenna (20). The line contact sensor antenna communications connector (23) and the line contact sensor antenna power connector (26) are fastened to the line contact sensor antenna cover (25). The line contact sensor antenna circuit board (22) is fastened to the line contact sensor antenna base (21) with circuit board screws (13). The cover screws (14) fasten the line contact sensor antenna cover (25) to the line contact sensor antenna base (21).

As shown in FIG. 100, the line contact sensor (19) senses when the heavy equipment (17) comes into contact with the high voltage lines (18) and communicates the contact condition to the remote panel transceiver antenna (58) using the radio link (47). The remote panel transceiver antenna (58) communicates the contact condition to the remote panel (50) to provide an annunciation from the speaker (65) to warn the operator of the heavy equipment (17) and personnel in the vicinity of the heavy equipment (17) of the dangers involved in coming into contact with the heavy equipment (17).

As shown in FIGS. 100, 103, 111, and 112, the operator panel (41) provides the operator interface for the operator of the heavy equipment (17) and the high voltage warning system utilizing wireless sensors. The signal level (62) and the alarm setpoint (3) are provided on the operator display (40) located on the operator panel (41). The signal level (62) provides the operator with a numerical value of the highest electrical field sensed by the array of the radio linked proximity antennas (48) located on the heavy equipment (17). The alarm setpoint (3) can be adjusted by the operator of the heavy equipment (17) to provide a margin of safety for the operator. The raise pushbutton (49) and the lower pushbutton (38) are provided to allow the operator of the heavy equipment (17) to change the alarm setpoint (3). When the signal level (62) exceeds the alarm setpoint (3), the alarm light (1) is lighted and the alarm annunciation from the speaker (65) is activated. In addition, the alarm relay (2) is actuated. The alarm condition is cleared whenever the signal level (62) drops below the alarm setpoint (3). For example, a higher setting of the alarm setpoint (3) would allow the heavy equipment (17) to approach the high voltage lines (18) much closer than a lower setting.

As shown in FIGS. 100, 103, 111, and 112, a warning feature is also included. A warning light (68) is lighted whenever the signal level (62) is at a predetermined value below the alarm setpoint (3). When the warning light (68) is lighted, a warning annunciation from the speaker (65) is activated. In addition, the warning relay (69) is actuated. The warning condition is cleared whenever the signal level (62) drops below the predetermined value below the alarm setpoint (3).

A new and useful high voltage proximity warning system utilizing wireless sensors and method have been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A device mounted on heavy equipment that is designed to measure and display the electric field strength of high voltage lines when said heavy equipment is in the immediate vicinity of said high voltage lines comprising:
one or more radio linked proximity antennas mounted on said heavy equipment for detecting the said electric field strength of said high voltage lines in the vicinity of said heavy equipment; and
a control panel designed to communicate wirelessly with each said radio linked proximity antenna and designed to select the highest electric field strength signal from said radio linked proximity antennas and display a value that represents said electric field strength;
wherein the highest value of said electric field strength sensed by said radio linked proximity antennas is displayed on said control panel.

2. The radio linked proximity antennas of claim 1 comprising:
a ground plane that is closely capacitively coupled to the chassis of said heavy equipment;
a signal plane that capacitively senses the presence of said high voltage lines;
an antenna controller that measures the voltage difference between said ground plane and said signal plane; and
an antenna transceiver that communicates information from said antenna controller to said control panel;
wherein a radio signal provides communication information from said radio linked proximity antenna to said control panel that includes information pertaining to said electric field strength of said high voltage lines as sensed by the electrical voltage difference between the voltage sensed by said ground plane and said signal plane.

3. The control panel of claim 1 comprising:
a control panel transceiver that receives radio signal information representing said electric field strength from said radio linked proximity antenna;
a display that provides an indication of said electric field strength;
an alarm unit that provides visual, audio, and control functions to the operator of said heavy equipment, adjacent personnel and said heavy equipment; and
a control panel controller that provides coordination for the functions of said control panel transceiver, said display, and said alarm unit;
wherein said control panel controller compares the value of said signal level indication to value of said alarm setpoint indication to determine the actions of said alarm unit.

4. The display of claim 3 further comprising;
a signal level indication that provides a visual representation of said electric field strength; and
an alarm setpoint indication that is displayed on said display that provides a visual indication to the operator of said heavy equipment of the maximum allowable signal level indication that would provide a safe operating environment for the operator of said heavy equipment;
wherein said display provides the operator of said heavy equipment a continuous indication of said electrical field strength and said alarm setpoint indication.

5. The alarm unit of claim 3 further comprising:
a visual alarm indication that provides a visual indication to the operator of said heavy equipment when the value of said signal level indication exceeds the value of said alarm setpoint indication;
an alarm annunciation device that provides an audible indication to the operator of said heavy equipment and other personnel in close proximity to said heavy equipment when the value of said signal level indication exceeds the value of said alarm setpoint indication; and
an alarm control device for generating control signals that affect the operation of said heavy equipment when the value of said signal level indication exceeds the value of said alarm setpoint indication;
wherein said alarm unit provides visual indications for the operator of said heavy equipment;
wherein said alarm unit provides audible annunciations for the operator of said heavy equipment and other personnel in close proximity to said heavy equipment; and
wherein said alarm unit provides control signals that affect the operation of said heavy equipment.

6. A method for installing a high voltage proximity warning system utilizing wireless sensors on heavy equipment, the method comprising;
installing said radio linked proximity antennas onto said heavy equipment in locations that are likely to come into contact with said high voltage lines;
installing said control panel onto said heavy equipment in a location that would be clearly visible to the operator of the said heavy equipment;
connecting said alarm control device to the control circuitry of said heavy equipment; and
connecting said control panel to a source of electrical power.

7. A method for operating a high voltage proximity warning system utilizing wireless sensors on heavy equipment, the method comprising;
monitoring the value of said signal level indication to insure that said signal level indication does not exceed the value of said alarm setpoint indication when said heavy equipment is operated in the vicinity of said high voltage lines; and
responding to said visual alarm indication and said alarm annunciation device to avoid operation of said heavy equipment in close proximity to said high voltage lines.
